(19) United States
(12) Patent Application Publication
(10) Pub. No.: US 2003/0233311 A1
(43) Pub. Date: Dec. 18, 2003

(54) Method and system for providing goods and/or services

(75) Inventors: Arnold H. Bramnick, Boca Raton, FL (US); Juan F. Caraballo, Boca Raton, FL (US)

Correspondence Address: Richard A. Tomlin, IMB Corporation (Internal Zip 40416), 8051 Congress Avenue, Boca Raton, FL, 33487, US

(73) Assignee: International Business Machines Corporation, Armonk, NY

(21) Appl. No.: 10/173,490

(22) Filed: Jun. 14, 2002

(51) Int. Cl. G06F 17/60

(52) U.S. Cl. 705/37; 705/26

(57) ABSTRACT

A system and method of providing goods and/or services to a customer who has defined a proposed purchase (such as a trip) which includes multiple components. The proposed purchase is broken down into components, bids are sought on each component and then a total price is presented for acceptance to the customer based on a combination of the best bids for each component. The customer may view the prices for the individual components and selectively exclude components which are not desired based on what is offered, such as the supplier or the price, or may change the package to substitute bids from different suppliers and/or different items.

### CROSS REFERENCE TO RELATED PATENTS

The present invention is related to the following document, which is assigned to the owner of the present patent application and is specifically incorporated herein by reference:

Patent application Ser. No. 08/717,669 filed Sep. 23, 1996 by John F. Schumacher et al. and entitled “Buyer Agent Electronic Commerce System and Method”, a document which is sometimes referred to in this document as the Buyer Agent Patent.

### BACKGROUND OF THE INVENTION

1. Field of the Invention

The present invention relates to improvements in buying and/or selling products and services. More particularly, the present invention is a system and method for creating an improved consolidated proposal for a purchase, particularly for a traveler-defined trip, by dividing the proposed purchase (the trip) into separate components, securing one or more bids for each of the components and then allowing selection amongst the bids manually by the initiator or using automation (with logic for selecting from the bids based on predetermined criteria). The purchaser then may purchase the entire proposal or may selectively purchase portions of the proposal.

2. Background Art

Various approaches have been suggested for fulfilling the desires of a customer seeking to obtain a variety of goods and services, such as proposed travel. One approach is for the traveler to call his travel agent and outline his desire for travel and the requirements. The travel agent then asks the necessary questions about the travel—when and where, staying where (in what hotel), is a rental car needed, etc., and then the travel agent secures the components by searching (usually manually) for predefined travel packages (if one is available) or, if not, by searching for each component which fits the requirements of the traveler or proposing something different (a hotel in a different location, travel to a different airport, etc). This is a very labor intensive and time-consuming way to match the travel available with the needs of the traveler. In many cases the travel agent has not been to the locations mentioned and has only limited awareness of the geography and providers of desired travel components. For example, when a traveler goes to London and wishes a hotel and breakfast near “The City”, the travel agent may consult his resources for hotel and breakfast which are near The City; a restaurant in a given hotel is convenient, but a restaurant on another street may be nearly or quite distant.

One different approach is for the traveler to connect to a network like the Internet and get onto a website which offers travel and seek to find the necessary components on-line. Various providers have on-line sites identifying its offerings, sometimes with prices and packaged deals. Many of these sites, particularly those sponsored by a company in the business, offer travel from a single provider (such as a hotel chain) or from a small group of related sources.

Some web sites provide information and reservations on various forms of travel, such as the sites http://www.Travelocity.com or http://www.Expedia.com. Such sites, however, usually serve a limited number of suppliers who place on-line information about its offerings (frequently as paid advertisements) and its list or asking prices for such offerings (but not necessarily the lowest price it would accept). The traveler then must search multiple diverse databases and compare offerings and piece together travel from these diverse sources, often without the benefit of competition from would-be suppliers who know that they must compete on price.

Some web sites provide a mechanism for allowing an auction or a reverse auction to provide goods or services such as travel services at a reduced price. For example, Priceline.com (http://www.priceline.com) has proposed a system in which a traveler identifies travel dates for an airline trip and states the price he is willing to pay for that airline travel, then priceline.com provides an answer by e-mail as to whether that airline ticket is available for the price the traveler is willing to pay. Such a system does not provide the “lowest cost” travel since the travel may have proposed a higher price than the minimum the airline was willing to accept and does not deal with traveler-defined travel packages which includes multiple diverse types of reservations (airline, hotel, rental car, attractions, etc.), which are generally provided by different suppliers. Such a system also assumes that the traveler is willing to travel at any time during the travel day and make a number of connections or plane changes. Such anytime, connection-possible travel may be acceptable for the leisure traveler who is concerned solely (or at least primarily) about the cost of the travel, but often is ineffective for business travel, where the traveler wishes to set constraints on the travel, such as arriving by noon or departing after noon or direct flights only or travel during outside of the business day.

Frequently, there is no “standard” offering, even for a relatively common offering such as lodging. Some providers of lodging offer a room at different prices depending on how many people occupy the room. Some lodging includes complimentary features such as a breakfast and airport shuttle, while others charge additional for the parking of a car in the hotel garage, particularly in the downtown area of a large city. Thus, a quotation of a room rate may be misleading unless it is understood what is included and what is excluded with that room rate and particularly how the lodging offering compares with the needs and desires of the traveler. That is, complimentary shuttle to the airport may be valuable to a traveler who intends to rely on public transportation but it would be worthless to a customer who is renting a car, where the cost of parking the car at the hotel (if any) would be a concern. Thus, estimating the cost of travel has been difficult and is subject to surprises as well as prices which may include extras which are not useful to a particular traveler and may omit items of cost which are needed by the traveler.

For the reasons stated in the foregoing paragraph, finding the low cost provider of travel has been difficult. A room for $100 per night might seen more expensive than the hotel down the street which offers a room for $90, but if the $100 per night hotel room includes breakfast and a free shuttle (and the traveler plans to use those services), then it could be more advantageous than the $90 per night room where cab fare might add $20 and a breakfast might add $10 to the cost.

Accordingly, systems for providing composite offerings (such as travel) have undesirable disadvantages and limitations that will be apparent to those skilled in the art in view of the following description of the present invention.

### SUMMARY OF THE INVENTION

The present invention overcomes the disadvantages and limitations of the prior art systems by providing a simple, yet effective, method and system for providing a method and system for fulfilling a customer's diverse and unique requirements (e.g., for travel) at the lowest possible cost

The present invention involves taking a customer's desired purchase such as a traveler-defined trip and breaking it into components, putting each component out for bid separately to appropriate potential suppliers, receiving the bids and determining the best bid for each component based on several factors, including but not limited to price, then assembling the best bids for the components into a proposal for the customer. In one embodiment of the present invention, the customer would see all bids and may elect to accept any bid the customer chooses (allowing the customer to accept a bid for higher-priced hotel room, based on a customer's preference regarding quality or location, or to accept a higher non-stop fare for air travel), while in another embodiment, the customer is presented with a bottom line price for the package based on use of the best bids. Alternatively, the customer may have already indicated that a price at or below a certain level is acceptable and therefore, if cost of the desired purchase (e.g., the travel) is less than the certain level, the customer automatically accepts the proposal. An alternative extension of the present invention allows the customer (the traveler) to see the price components and to pick and choose which components are offered at an acceptable price (and reject the ones the customer does not wish to accept). For example, if the price for the rental car is considered excessive or expensive, the traveler may reserve no ground transportation through the service and instead rely on finding public transportation such as taxis or buses at the destination. If the customer is purchasing construction, the cost of a component for purchase may be compared with the cost the customer incurs to perform the activity himself and if the customer is seeking bids on insurance and the excess layer is priced higher than the customer considers its value, the customer may consider going without that coverage.

Such a system of the present invention allows the customer to define his proposed purchase (his trip) according to the customer's needs and/or desires, then determine the best available price for the purchase.

Such a system and method allow for a customer (e.g., traveler) to receive a lower price for travel than if a single supplier provided a single bid for the package.

The present system also allows for a customer to view the component cost and determine which components are considered expensive and/or overpriced and to selectively delete such components from the proposed purchase (the travel).

The present invention also allows the traveler to identify which components of the proposed travel are considered necessary and which are considered desirable (but not necessary). Further, it allows the traveler to specify components that are unnecessary (such as a breakfast or complimentary airport shuttle service which would not be used by the traveler).

Other objects and advantages of the system and method of the present invention will be apparent to those skilled in the relevant art, in view of the following description of the preferred embodiment, taken together with the accompanying drawings and the appended claims.

### BRIEF DESCRIPTION OF THE DRAWINGS

Having thus described some of the objects and advantages of the present invention, other objects and advantages will be apparent to those skilled in the art in view of the following description of the invention taken in conjunction with the accompanying drawings in which:

FIG. 1 is a diagrammatic view of a system of customers and potential suppliers interacting with a central system useful in understanding the present invention;

FIG. 2 is a flow chart illustrating the steps involved in the present invention;

FIG. 3 illustrated a web page which a proposed customer (a traveler in the illustrative example of this Figure) completes to indicate his proposed purchase (a trip which he has planned in this instance);

FIG. 4 illustrates a response to the proposed customer generated by the system of the present invention in response to his proposed purchase as completed in FIG. 3;

FIG. 5 illustrates an example of details of a package included a bid response of FIG. 4 from the system of the present invention in response to a proposed trip as described in connection with FIG. 3;

FIG. 6 illustrates bid details for a selected portion of the proposal of the bid response of FIG. 5;

FIG. 7 illustrates an alternate bid response for a package bid; and

FIG. 8 illustrates a return message from the customer indicating an acceptance by the customer to a system's proposal, in an alternate embodiment of a bid proposal.

### DETAILED DESCRIPTION OF THE PREFERRED EMBODIMENT

In the following description of the preferred embodiment, the best implementation of practicing the invention presently known to the inventor will be described with some particularity. However, this description is intended as a broad, general teaching of the concepts of the present invention using several specific embodiments but is not intended to be limiting the present invention to that as shown in these embodiments, especially since those skilled in the relevant art will recognize many variations and changes to the specific structure and operation shown and described with respect to these figures. As will be discussed later, the present invention is described for illustration in the context of a system for making travel arrangements but it is not limited to that type of application and has applicability to other forms of transactions where multiple components from different sources may be involved.

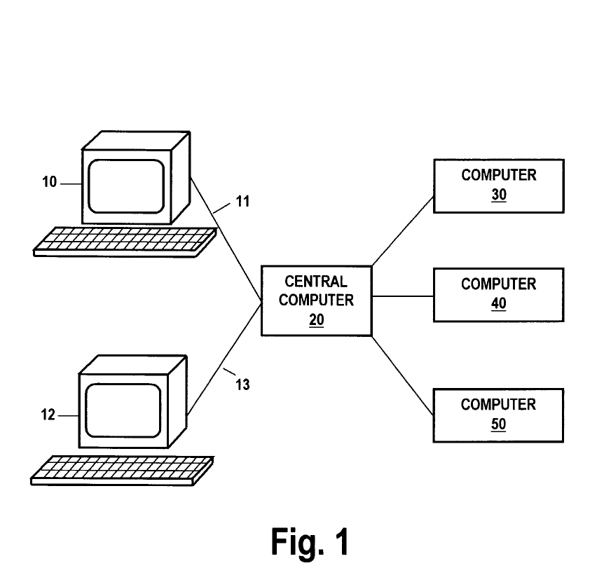

FIG. 1 illustrates a terminal 10 for a first purchaser or customer connected to a central processor 20 in a conventional manner using a phone line or other connection to the Internet, illustrated by the line 11. The central computer 20 includes logic to perform the processes involved and includes a connection to other computers 30, 40 and 50 for sending and receiving messages in a conventional manner between the central computer 20 and proposed suppliers who are related to the other computers 30, 40, 50. A second terminal 12 for a second purchaser or customer is also shown connected to the central computer 20 by line 13 for the purpose of illustrating the present invention, illustrating that the present invention is directed to serving a plurality of customers, in that any number of customers or purchasers may be connected to the central computer 20 at any time, and the central computer 20 may be connected to the other computers 30, 40 and 50 either in a real time system or in a batch mode, where messages are accumulated and handled at a later time. Also, given the present invention as will be explained in some detail, the present invention is not limited to communications between computers and may be implemented by other methods of sending requests for quotes to prospective suppliers and receiving the responses, although it is believed that the preferred way to implement the present invention uses a computer implementation and communications over a network.

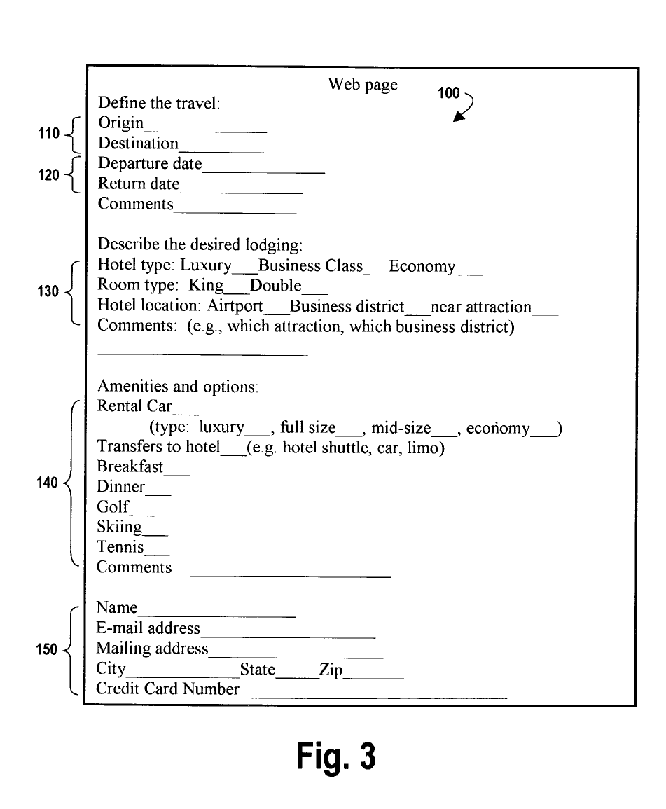

A potential purchaser or customer who wishes to make a purchase (in the case illustrated, to define a trip) and use the present invention sends a message (preferably using his computer 10, although the purchaser may use an agent such as a secretary or travel agent to enter the details in the computer associated with the agent rather than operated by the customer himself) to the central processor 20 identifying the details of the proposed purchase (for a trip—the date, origin, destination, needs and preferences for hotel room, rental car, attraction information, ground transportation, etc.), all using conventional data transmission techniques and messaging formats which are well known in the industry and may be in the form of an e-mail or in the form of completing a web page by filling in the appropriate blanks as is illustrated in connection with FIG. 3.

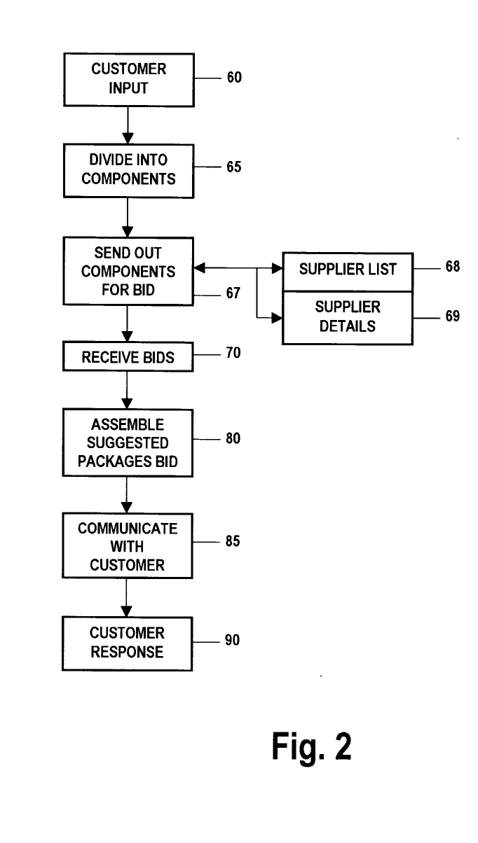

The logic of the present invention is that the customer or traveler identifies (at block 60 in FIG. 2) the particulars of the proposed purchase, a trip in this case, indicating the date of departure, the date of return, the need for hotels (with any preference for location and type), ground transportation (including rental car or limo) and any other amenities that are either desired or required (restaurant, sporting event, amusement park, recreation, etc.). At block 65, the central processor 20 divides the travel into segments or components and sends each segment out to one or more potential bidders, preferably using electronic data interchange or other electronic communication. While these components could be posted on a bulletin board or broadcast generally to a listing of available suppliers, a targeted distribution is more desirable in that a request for hotels be sent to suppliers of hotel rooms (hotel chains, motel chains, individual hotels and motels, bed-and-breakfasts, and travel agencies) while requests for airline transportation be routed only to suppliers of airline transportation at block 67. That is, a listing of potential suppliers of individual types of components is maintained, along with a listing of accommodations provided and not provided, so that the requests for quotes on travel components are only sent to likely bidders. The targeted list allows entry of the airline flight service components (for example, that Continental Airlines serves Cleveland airport and Newark airport but does not serve Charlotte airport) and allows for a hotel chain to indicate that it has hotel rooms and suites in a multi-floor tower and offers room service and restaurant service but does not offer a bed-and-breakfast. The service listing also can include the locations of the hotels, both by geography (in a list of cities) and by location within each city (at the airport, in the downtown area, near a local attraction, etc.) to allow identification of which service provider may be able to provide the desired accommodations and which providers are unlikely to fulfill a request.

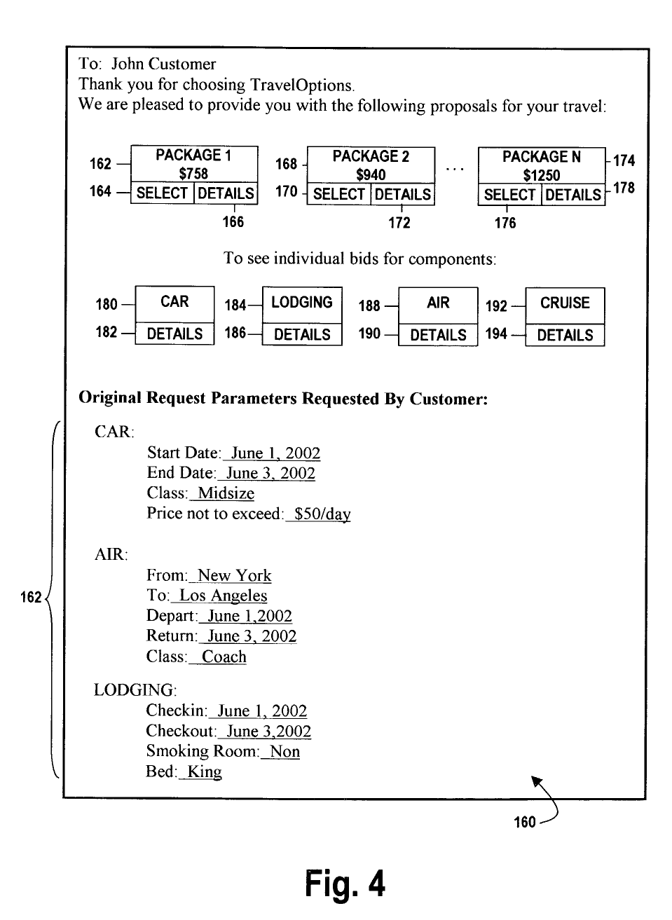

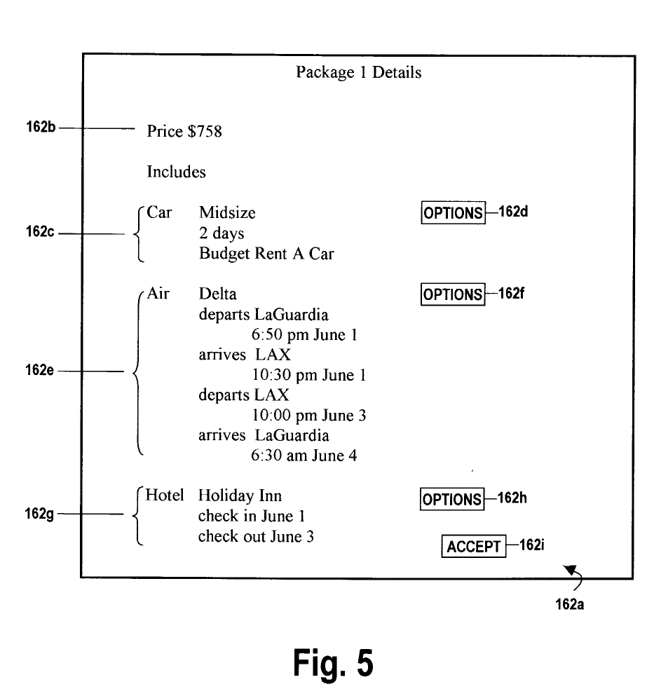

Bids on each of the segments are then received at block 70. One or more combination(s) of the bids are then made and assembled into package price(s) for the entire trip at block 80, which is then communicated to the customer at block 85 in a response as shown and described in connection with FIG. 4. The customer then elects whether to accept the price on a package or assemble his own from the bids returned at block 90 (as shown and described in connection with FIG. 5) and advise of his decision through communication, preferably by an electronic message or e-mail transmitted over the Internet. If the customer accepts the bids (either for an entire trip or selected components of the trip), then the vendors of the winning bids for each component are notified that they have a customer, with his name and other pertinent information such as his credit card.

Of course, the idea of receiving information on a potential purchase, dividing the potential purchase into separate components and sending each of the components to several potential bidders is not limited to travel but may be used in other situations. A restaurant may want to order linen, beverages, fish, meat and produce and the present invention could receive details regarding the proposed purchase, divide it into components and send each of the components out to potential suppliers for bids in much the same way that a proposed itinerary is broken down into components and bids solicited for each component. In a similar way, a business such as a hotel may seek a variety of services (housekeeping, trash collection, maintenance of grounds, etc.) and seek bids on providing these services. Thus, the present invention is intended to present a solution for providing a variety of goods and/or services to a customer and is not particularly limited to any particular set of services.

FIG. 3 illustrates a web page for a potential purchaser (e.g., a traveler) to complete with the particulars of his trip. The web page 100 includes a first section 110 about the origin and destination, a second section 120 about the date(s) of travel, a third section 130 about lodging and a fourth section 140 about the amenities desired Identification information regarding the traveler is provided in a fifth section 150 of the web page. In this section, the name of the traveler and his address (an e-mail address for electronic communications, with a postal address being optional in case a printed copy of materials such as an airline ticket or other material must be delivered) are entered for identification. A credit card number is collected and validated to discourage mischievous use of the system and add security. While some of these items could be on separate web pages which are selected from a menu on a first web page, for ease of description they are shown on a single web page.

The web page of FIG. 3 includes, optionally, various places for comments to be entered by the traveler, such as a preference for ground floor room, a no smoking room, departure in the evening, etc. Which then can be handled by the central computer or passed along to the potential provider of the particular accommodation, such as lodging or air travel.

FIG. 4 illustrates one format for a quote for travel components, prepared by the system described in connection with the preceding figures, particularly FIG. 2. In this example, various buttons provide hotlinks to packages which have been assembled and detail pages of the various bids which were obtained. In this view a bid response 160 is presented in the form of a webpage with hyperlinks, although a bid in the form of an e-mail or other format is certainly within the scope of the present invention. The bid response includes several packages which have been assembled based on predetermined criteria, such as economy, luxury, full-service, etc. and grouped into packages designated as package 1 (represented by the box 162), package 2 (represented by the box 168) and package N represented by the box 174. Associated with each box are two hotlinks, one to select the package and a second one for details. Thus, a selection button or hotlink 164 and a details button or hotlink 166 are associated with the box 162 for package 1. Similar buttons are associated with package 2 and package N. In this way, a customer may either look at the price and make a selection or he may look at the underlying bid details to see who the providers are, where the hotel is located, etc.

In a similar manner, the traveler may look at the bids for the individual components by a second set of buttons. Thus, the detail on a rental car can be obtained by clicking on button 182, the details on lodging can be obtained by clicking on button 186, the details on air service can be obtained by clicking on button 190 and the details on a cruise can be obtained by clicking on the button 194. Additional buttons or substitute buttons are handled in a similar fashion and can represent other components of the package and details on suppliers and their offers.

FIG. 5 illustrates the detail on a package (package 1 in FIG. 4, obtained by clicking on the button 166). The details, which may depend on the requirements of the customer, include a price for the package represented by reference numeral 162b and the individual components which in this case include a rental car quote represented by reference numeral 162c, an air travel quote represented by reference numeral 162e and a hotel quote represented by the reference numeral 162g. Associated with each component is a button for options which provide details of alternate quotes which are available: in this case, options for the rental car are indicated by a button 162d, options for the air travel by button 162f and for hotel by the button 162h. The customer can click on any of these (singly or by recursive selection) to get the details on other options available to him and he may select an alternate (which may be more desirable to him, even though the computer had selected another quote as being more appropriate or desirable, given the selection criteria which was established). When the customer selects a different quote, the package price and the supplier as shown in FIG. 5 are changed accordingly. When the customer has arranged for the selections he desires and wishes to select the trip, he clicks on the accept button 162i and his transaction (with the selected accommodations) is reserved for him, with an appropriate reply message or e-mail created, either directly or after the customer has entered the necessary information (like his credit card number, e-mail address, frequent travel information, etc., in another screen, not shown but of conventional design).

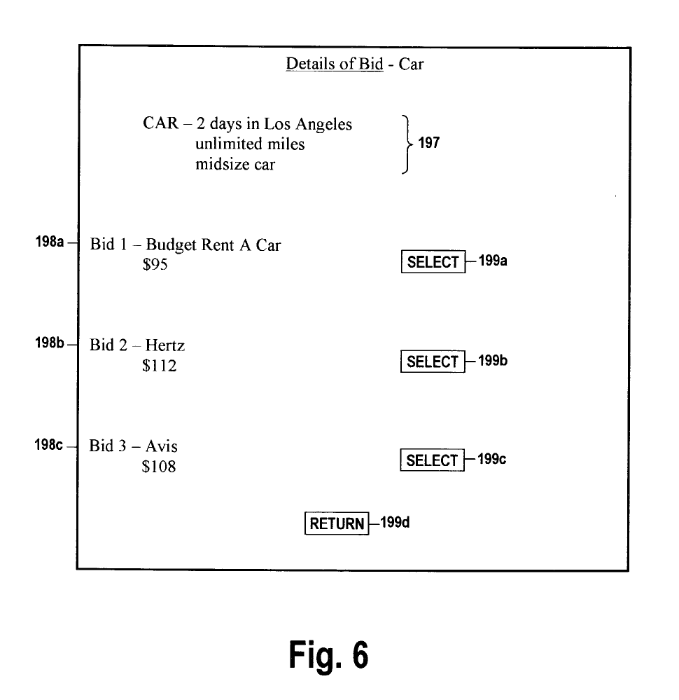

FIG. 6 illustrates the details of rental car options which are available tot he customer for his trip. In this case the details of the request are presented in a top section 197 and the bids which have been obtained are listed down the screen, in this case three: bid 1 from Budget represented by the reference numeral 198a, bid 2 from Hertz represented by the reference numeral 198b and bid 3 from Avis represented by the reference numeral 198c. Associated with each bid is a selection button: button 199a associated with bid 1, button 199b associated with bid 2 and button 199c associated with bid 3. In the preferred embodiment, the system will select one of the bids as the preferred and include that one in the package price. Such a bid might be included as the first bid for ease in understanding the bid and may not have a button associated with it since it is the default. Alternatively, the button for the default bid may be a button to exclude or cancel this component from the default package, if desired. Also shown in this view is a button 199d to return to the previous screen after the options have been reviewed and the selections have made. Similar detail pages can be used for other components of the package and the customer may review any of those detail pages as desired and change the package (with the attendant change in the cost).

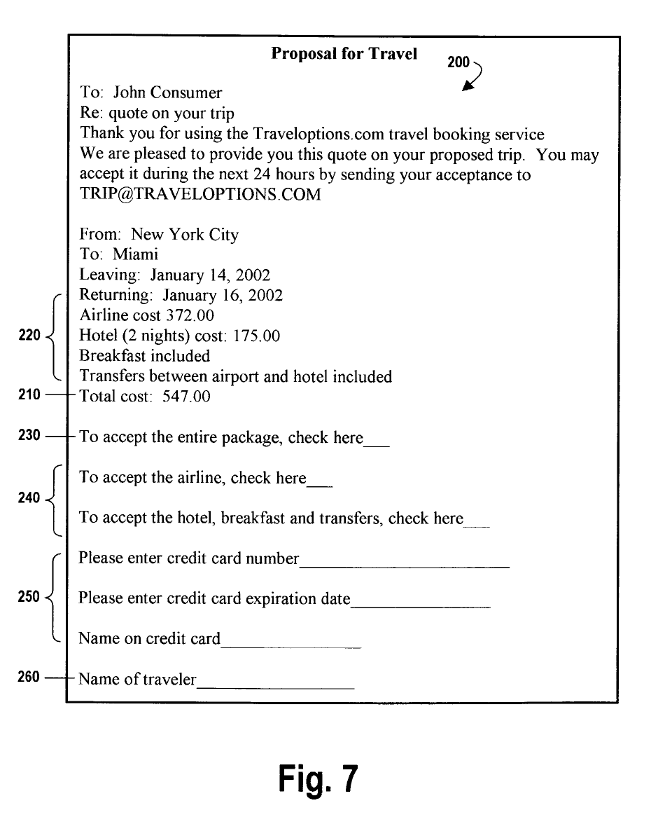

FIG. 7 illustrates one possible response from the system with a travel proposal. While this response is shown in the form of an e-mail message which results from the processing as disclosed in FIG. 2 for the traveler input of FIG. 3, the system response also could be provided in the form of a web page or other suitable response, even including fax, regular mail or telegram, if desired, either in place of or in addition to an electronic response. The response 200 includes a section 210 which shows the bottom line cost of the entire travel and a detail section 220 which breakdown of the components of the bid. The response includes a place 230 for the traveler to indicate acceptance of the entire package, places 240 for indicating acceptance of just a portion of the travel. The proposal 200 includes a place 250 to enter the credit card information for the charge of the travel cost and a line 260 where the name of the traveler is entered, since reservations usually require the name of the traveler and not just the name of the credit card holder.

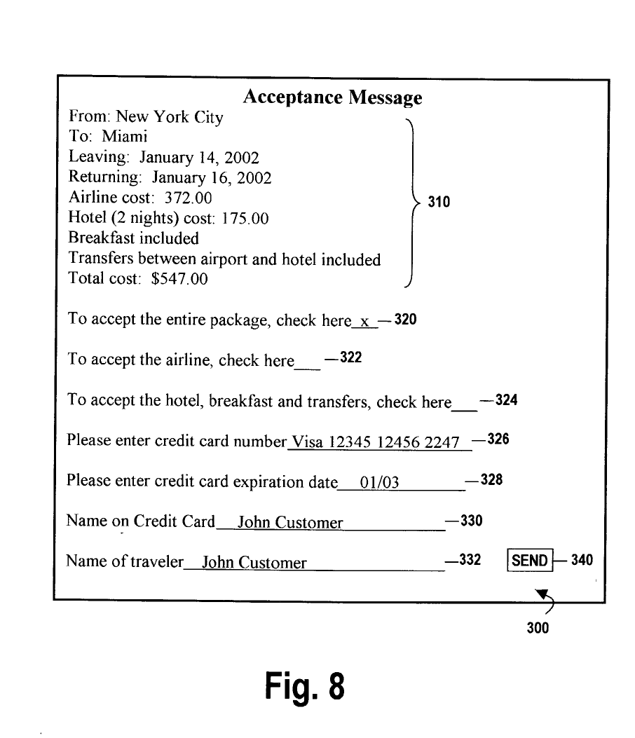

FIG. 8 illustrates the traveler's return message 300 indicating his acceptance of a travel proposal generated by the system as described in connection with FIG. 7. In this case, the traveler, John Customer, is accepting the entire package and charging it to his credit card, although certainly other forms of payment such as a wire transfer, account debit, payment upon delivery, etc. could also be used to advantage. In this case, the system has identified the proposed trip in the region 310, with an acceptance line 320 to accept the entire package and a place to accept only airline (322) or the hotel, breakfast and transfers (324). The credit card number and type is entered on line 326, expiration date on line 328, name on line 330 and traveler on line 332. Then the send button 340 is engaged to send the message.

FIGS. 7 and 8 illustrate a different travel proposal (and in a different format) from the proposal described in connection with FIGS. 4-6, although the principles remain the same. The data presented in an alternative to those details shown and described in connection with the example of FIGS. 4-6.

In any embodiment of the present invention, additional communication may be included in addition to that which is shown and explicitly described. For example, providing an identifier like a credit card number may allow for a customer's past history to be retrieved and displayed, either in whole or in part, to allow a customer to revisit past requests for bids, either as presented or with suitable changes (like the same trip from last month rescheduled for some time in the future, or a change in destination for a trip, going to Boston instead of New York, for example). The communication employed to advantage by the system may be of a type which is conventional, in that the system must seek bids initially and later confirm those bids with the successful bidders (when the customer accepts a package). The system must also confirm that a credit card is valid and that charges on it will be accepted and paid in the usual course of business, a process which is well known to merchants and to transactions using the Internet. Further, it is conventional to provide confirmation of a transaction, so when a customer elects a package, it is common for the customer to receive back a confirmation of the details (along with any relevant information, like confirmation numbers, telephone contact numbers, pricing and invoice information, etc.) and this information can be provided either through e-mail or other conventional communications techniques such as conventional mail, telegram, or a web page which can be printed, according to the desires of the user and the design of the system.

Further, the implementation of the system has been described in illustrative form without many of the details which are optional and could easily be added without departing from the spirit of the present invention. For example, the system can easily accommodate additional information to allow the booking of travel for more than one traveler. Further, the system could be used to advantage to include details about the proposed travel (such as breakfast and transfers to and from a hotel) which may be included with some providers and may be extra costs with other providers, by determining the customer's desire and whether such elements are a part of the provider's offering; if not, then the provider might be asked to provide a price (either a non-binding estimate or a confirmed bid) for such additional features, to make the bids comparable and to provide a more-realistic price. Additionally, since travel is a service which includes a commission to the agent actually booking the travel, the amount of the commission could be included in any communication so the agent could decide to change his commission, if desired.

The present invention may be implemented in a computer (such as a general purpose processor) loaded with suitable software. It may also be implemented through the use of a specialized processor or computer which is configured to perform the processing described in connection with the previous description. The present invention can be realized, according to the designer's interests, in hardware, software, or a combination of hardware and software. An image processing system according to the present invention can be realized in a centralized fashion in one computer system, or in a distributed fashion where different elements are spread across several interconnected computer systems. Any kind of computer system or other apparatus adapted for carrying out the methods described herein is suited for use in the present system. A typical combination of hardware and software could be a general purpose computer system like a personal computer or a personal digital assistant (PDA) with an appropriate set of computer programs that, when being loaded and executed, controls the computer system such that it carries out the methods described herein. Relevant portions of the present invention can also be embedded in one or more computer program products, which comprise at least selected portions of the features enabling the implementation of the methods described herein, and which, when loaded in a computer system, are able to carry out these methods and implement the present invention.

As used in the present document, software, computer program and computer program means are used interchangeably. Software in the present context means any expression, in any language, code or notation, of a set of instructions intended to cause a system having an information processing capability to perform a particular function either directly or after either or both of the following: a) conversion to another language, code or notation; b) reproduction in a different material form.

The foregoing description of the present invention has been made in the context of a system for making travel arrangements, although the system of the present invention described in this document is clearly not limited to that type of application. In fact, the present invention has applicability to other situations where multiple components and multiple potential suppliers for components may be involved. In particular, the present invention may be useful in the performance of construction projects or in the securing of insurance for various perils. In the context of construction projects, a prime contractor may separate the project into different type of work (masonry, framing, grading, finishing, etc.) or he may separate a construction project like a roadway into geographic segments. In the context of insurance, a business may have various requirements for insurance (product liability, real estate, automotive, medical, advertising, directors and officers insurance, umbrella, etc.) and even some components may be divisible (for example, flood insurance from other perils) or segmented (one layer from one company, a second layer from another company and the excess from a third). The present invention may be useful in separating the desired goods and/or services into pieces which are individually bid and the “best” bids combined into a quote for the thing desired.

Of course, many modifications of the present invention will be apparent to those skilled in the relevant art in view of the foregoing description of the preferred embodiment, taken together with the accompanying drawings and the appended claims. For example, the individual components may differ in different locations, for example, in a location where rental cars are not available, this portion of the proposed travel package might be deleted. Further, in some circumstances, other components might be added as desired by the customer: in the field of vacation travel, various leisure activities could be included as options to the traveler: tours or cruises, admission to amusement parks, temporary club memberships, golf or other sports, etc. Additionally, some elements of the present invention can be used to advantage without the corresponding use of other elements. For example, the various components may be optional to the traveler, such as a rental car, ground transportation and meals, and additional components can be included, if desired. Further, some suppliers may have a standing offer so that a separate communication for price and confirming availability may not be required, but the central computer would then rely on checking its memory to confirm the terms of a proposed offer and sending a confirming message to the supplier. Also, the concept of providing an estimate of the package price and receiving a commitment from the customer to purchase the package if the price based on bids is an optional extension of the process of putting the components out for bid. Further, the method by which an estimated price is calculated may be based on historical information (for example, typically bidders bid a discount of at least ten percent) or based on some kind of current information received from suppliers. Further, various other systems and devices could be substituted to advantage depending on the environmental circumstances of the present invention—for example, the customers could be using wireless devices (like mobile phones or handheld PDA devices) using wireless communications rather than computers and wired connections. Accordingly, the foregoing description of the preferred embodiment should be considered as merely illustrative of the principles of the present invention and not in limitation thereof.

Having thus described the invention, what is claimed is:

1. A method of proposing a package of related goods and/or services to meet a customer's requirements, the method comprising the steps of:
receiving a customer's requirements;
dividing the customer's requirements into components;
submitting the components to multiple potential suppliers for a bid on each component;
receiving bids on each component from potential suppliers;
evaluating the bids for each component to determine the best price for the component; and
assembling the best bid price for each component into a proposal for the customer's requirements and presenting a combined price for the customer's requirements to the customer.

2. A method including the steps of claim 1 wherein the method further includes the step of determining that the bid on a component match the customer's requirements and for indicating the extent to which the requirements are satisfied.

3. A method including the steps of claim 1 wherein the step of presenting a combined price for the customer's requirements further includes providing the prices of the individual components and allowing the customer to selectively include or exclude components in a package with the price adjusted accordingly.

4. A method including the steps of claim 1 wherein the method further includes the step of generating an estimate of the package price based on stored information and providing that estimate to the customer before the prices for the components are received from the potential suppliers.

5. A method including the steps of claim 1 wherein the method further includes the step of obtaining a commitment from the customer to purchase the package if the price meets certain qualifications.

6. A method including the steps of claim 5 wherein the step of obtaining a commitment from the customer to purchase is based on the price for the proposed travel not exceeding an estimated price for the proposed travel.

7. A method including the steps of claim 1 wherein the method further includes consulting a database of potential suppliers for each component.

8. A method including the steps of claim 7 wherein the step of consulting a database of potential suppliers includes determining information about the offerings of the potential supplier.

9. A method including the steps of claim 8 wherein the step of determining information about the offerings of the potential supplier is compared with the requirements to determine whether to seek a bid from the potential supplier.

10. A system for providing a package price for a package defined by a customer, the system comprising:
a database of potential suppliers;
a system for receiving a request from a potential customer, breaking the request into components and for comparing components of the request with the database of potential suppliers;
if the potential suppliers match the request from a potential customer, a communication system for querying the potential supplier about his price for a component which the potential customer requests;
a system for accumulating bids on components of the request from a potential customer into a bid on the combined request;
a system for communicating the bid for the combined request and its components to the potential customer for his acceptance; and
a system for receiving an acceptance of the bid by the potential customer.

11. A system including the components of claim 10 and further including a system for providing the package price to the customer and for receiving a request for details and for providing details to allow the customer to see bids of alternative suppliers.

12. A system including the components of claim 11 and further including a system for allowing the customer to change the components of the combined request and for accepting a bid based on the changed components.

13. A program for receiving a definition of a proposed purchase and for providing a price for that purchase, the program comprising:
a module for receiving a customer's definition of a proposed purchase;
a module for separating the proposed purchase into separate components;
a module for sending each separate component to a supplier for a price for the separate component;
a module for receiving a price from the supplier and for comparing the prices for the separate components to determine the best price for the component;
a module for assembling the best price for each component into a bottom line bid for the proposed purchase; and
a module for providing the customer with a bottom line price for the proposed purchase.

14. A program including the modules of claim 13 wherein the module for providing the customer with a price for the proposed purchase includes providing the customer with a list of the component prices.

15. A program including the modules of claim 13 wherein the program further includes a module for receiving a response from the customer accepting at least part of the proposed purchase.
